(19) United States
(12) Patent Application Publication
(10) Pub. No.: US 2026/0104510 A1
(43) Pub. Date: Apr. 16, 2026

(54) TWO DIMENSIONAL OPTICAL PHASED ARRAY PHOTONIC INTEGRATED CIRCUIT FOR FOCUSED OPTICAL IMAGING ENABLING SCANNING AND ADAPTIVE OPTICS FOR BIOPHOTONICS

(71) Applicant: TAARA CONNECT, INC., Sunnyvale, CA (US)

(72) Inventors: Sanam Mozaffari, San Francisco, CA (US); Stephen Palese, Menlo Park, CA (US)

(21) Appl. No.: 19/305,246

(22) Filed: Aug. 20, 2025

Related U.S. Application Data
(60) Provisional application No. 63/707,455, filed on Oct. 15, 2024.

(51) Int. Cl. G01S 17/894; G01S 7/481; G02F 1/295

(52) U.S. Cl. CPC G01S 17/894; G01S 7/4816; G02F 1/2955

(57) ABSTRACT

Aspects of the disclosure provide an optical imaging device. The optical imaging device may include a source configured to generate signals; an optical phased array (OPA), operatively coupled to the source, the OPA being configured to transmit signals from the source towards an object to be imaged; a receiver configured to receive resultant signals from the object, wherein the resultant signals are based on the transmitted signals and the resultant signals include at least one signal relating to excitation of the object; and one or more processors operatively coupled to the OPA, the receiver, and the source, the one or more processors configured to generate an image based on received resultant signals.

### A CROSS REFERENCE TO RELATED APPLICATIONS

The present application claims the benefit of the filing date of U.S. Provisional Application No. 63/707,455, filed Oct. 15, 2024, the entire disclosure of which is incorporated by reference herein.

### BACKGROUND

Optical imaging systems use a point scanning beam to achieve high resolution compared to a widefield scan. A point source scans across a substance and the light reflected is captured at a conjugate plane. The optical quality of this point source determines the resolution and the finer the illuminated point source and the detected point source, the optical resolution of the image is enhanced. Image enhancements may include retention of depth information as well as improved contrast ratio and reduced scattering for improved clarity. These improvements may be especially relevant to physically thick or optically turbid objects.

### BRIEF SUMMARY

Aspects of the disclosure provide an optical imaging device. The optical imaging device may include a source configured to generate signals; an optical phased array (OPA), operatively coupled to the source, the OPA being configured to transmit signals from the source towards an object to be imaged; a receiver configured to receive resultant signals from the object, wherein the resultant signals are based on the transmitted signals and the resultant signals include at least one signal relating to excitation of the object; and one or more processors operatively coupled to the OPA, the receiver, and the source, the one or more processors configured to generate an image based on received resultant signals.

In one example, the source, the OPA, and the one or more processors may be included on a first photonic integrated circuit (PIC). Additionally, the receiver may be included on the first PIC. Additionally or alternatively, the optical imaging device may further include a plurality of PICs each including a source, and an OPA. Additionally, each PIC of the plurality of PICs may have a differing field of view (FOV). Additionally or alternatively, the first PIC and the plurality of PICs are formed in an array. Additionally, the array may be a hollow cylinder.

In another example, the optical imaging device may further include a mirror configured to direct signals from the OPA towards the object to be imaged and resultant signals towards the receiver. Additionally, the mirror may be a dichroic mirror including different reflection or transmission properties of signals at different wavelengths.

In an additional example, the optical imaging device may further include a lens group including one or more beam extending lenses, the beam extending lenses configured to increase a numerical aperture of signals directed towards the object to be imaged.

In another example, the optical imaging device may further include a lens configured to focus signals onto the receiver.

In a further example the receiver may include a camera, a photomultiplier tube (PMT), or a single photon counting superconducting nanowire array.

In another example, the receiver may include one or more amplifiers and one or more photodiodes.

In an additional example, the image may be a 3D image.

In a further example, the image may include both structural and spectroscopic information of the object. Additionally, the spectroscopic attributes may include at least one or more of temperature, material identification or biological functionality level determinations.

Another aspect of the disclosure provides a method of optical imaging. The method may include generating, by one or more processors of a device, a first signal having a first imaging depth; generating, by the one or more processors of the device, a second signal having a second imaging depth; transmitting, by an optical phased array (OPA) of the device, the first signal and the second signal towards an object to be imaged; receiving, by the OPA of the device, a third signal from the object, wherein the third signal is a resultant signal of the first signal, the resultant signal relating to excitation of the object; receiving, by the OPA of the device, a fourth signal from the object, wherein the fourth signal is a resultant signal of the second signal; and generating, by the one or more processors of the device, an image based on the third signal and the fourth signal.

In one example, the device is an optical imaging device.

In another example, the object includes biological tissue.

In a further example the first imaging depth is different from the second imaging depth.

### BRIEF DESCRIPTION OF DRAWINGS

FIG. 1 illustrates a pictorial diagram in accordance with aspects of the disclosure.

FIG. 2 represents features of an optical phased array architecture in accordance with aspects of the disclosure.

FIGS. 3A-3B illustrate pictorial diagrams of a device in accordance with aspects of the disclosure.

FIG. 4 illustrates a pictorial diagram of a device in accordance with aspects of the disclosure.

FIG. 5 is flow diagram in accordance with aspects of the disclosure.

### DETAILED DESCRIPTION

### Overview

The technology relates to a device including an optical phased array (OPA) disposed on a photonic integrated circuit (PIC). The device may be used in optical imaging. The optical imaging may include imaging of an object. The object may be, for example, a tissue sample, a human, an animal, etc.

Generally, most optical imaging systems use a point scanning beam with conventional static optical elements such as lens and/or mirrors to achieve high resolution compared to a widefield scan. A point source scans across a substance and the light reflected is captured at a conjugate plane. The optical quality of this point source determines the resolution and the less aberrated the illuminated point source and the detected point source, the optical resolution of the image is enhanced. Such techniques can be time consuming, costly, and allow for little adjustability.

To address this, as noted above, a device may be implemented using PICs with OPAs. In this regard, the imaging device may utilize the functional capabilities of the OPA to facilitate imaging over larger areas and depths with decreased complexity and cost. Use of the OPA may also enable focusing of light or signals onto specific targets within the object for more localized and enhanced interactions. Moreover, due to the small size, low power consumption and inert material basis of imaging devices including a PIC, such devices may be utilized for external and internal body imaging applications. Additionally such devices may be configured to be implanted within a human, animal, etc., for longer term, real time, monitoring or therapeutic applications.

### Example Systems

As discussed above, a device or imaging device may be used in optical imaging. The imaging device may include a PIC therein. The PIC may include an OPA configured to transmit and receive incoming and outgoing signals (e.g. beams used for active manipulation of the object) and/or images. In this regard, an imaging device (e.g. optical imaging device, camera, medical imaging device, etc.) may be configured to image an object. The object may be, for example, a tissue sample, a human, an animal, etc.

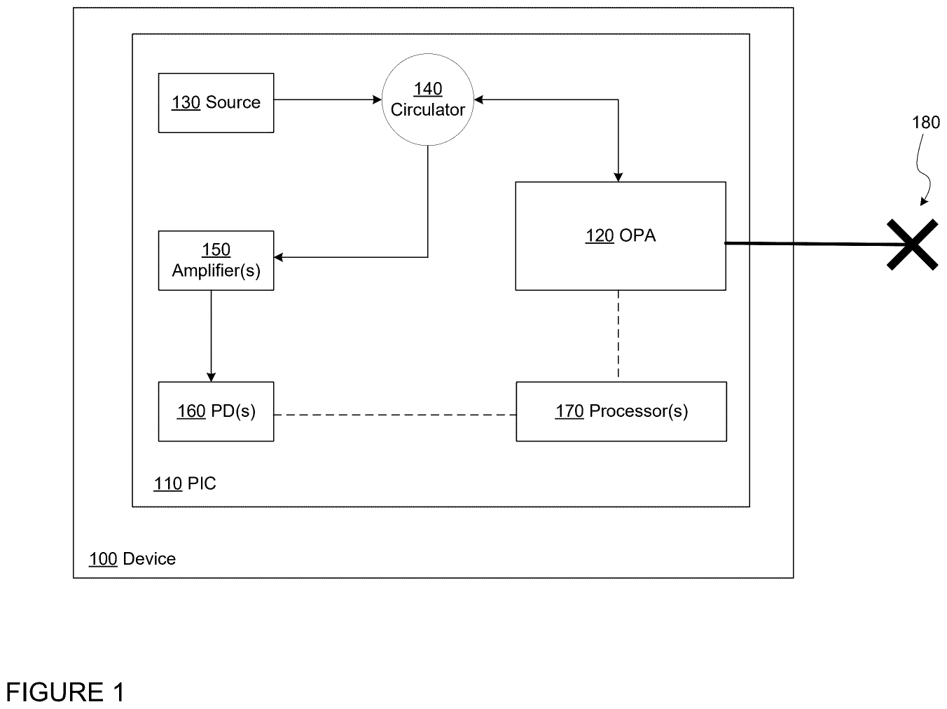

FIG. 1 illustrates an example imaging device 100. Imaging device 100 includes PIC 110. The PIC 110 as illustrated includes an OPA 120, a source 130, a circulator 140, one or more amplifiers 150, one or more photodiodes (PDs) 160, and one or more processors 170. The PIC 110 may be configured to transmit one or more signals (e.g., optical signals) directed at an object 180 to be imaged. The PIC 110 may be further configured to receive signals. The signals received may be signals resulting (e.g., resultant signals) from the transmitted signals. In this regard, the received signals may be the transmitted signals reflected back from the object 180. Additionally or alternatively, the received signals may be the result of excitation of the object 180.

For example, a first signal (e.g. beams used for active manipulation of the object) may be transmitted from the PIC 110 to the object 180 to be imaged of a portion thereof. The first signal may excite the object 180 or a portion thereof such that a second signal may be emitted and received by the PIC 110.

The excitations can include, but not be restricted to, single wavelength excitation; dual wavelength excitation, and coherent superposition. Single wavelength excitation may include excitation using a single wavelength. Single wavelength excitation may be used for measurements of physical attributes such pressure, velocity, density, biological activity, temperature, material ablation and surgical removal structure sculpting and 3D dimensional modification polymerization and growth of 3D structures photo-activation of photosensitizing drugs (e.g., for cancer treatment). Dual wavelength excitation may include excitation using two wavelengths. Dual wavelength excitation may be used for coherent ultrasound generation for deeper object penetration, Raman excitation for material identification, and O2 saturation levels. Coherent superposition excitation may use a plurality of wavelengths and may provide a localized effect that leaves surrounding areas unaffected.

When transmitting signals directed at the object 180 to be imaged, the one or more processors 170 may induce the source 130 to generate signals (e.g., light). The source 130 may be a distributed feedback laser (DFB), a laser diode, a fiber laser, a solid-state laser, an extended cavity diode laser (ECL), or a seed laser. The one or more processors 170 may be configured to control the source 130 to generate signals at specific wavelengths. The wavelength of the signals may be selected for control of imaging depth, imaging range, etc.

In some instances, the source 130 may be a semiconductor optical amplifier (SOA) configured to generate signals and allow control of a power level of signals (e.g., amplify). The power level control may allow for control of imaging depth, imaging range, etc. For example, increased power may allow for increased imaging depth within the object 180. Similarly, decreased power may allow for decreased imaging depth including surface level imaging of an object 180. Additionally, the power level may be controlled such that the level remains within a safe range for the object 180 being imaged. For example, if the object 180 includes biological tissue, the power level may be controlled such that the signals do not damage the biological tissue.

In some instances, the PIC 110 may be configured as a multi-wavelength PIC. In this regard, the source 130 may be configured to transmit a plurality of signals simultaneously. Each signal may be of a different power and/or wavelength and may allow for imaging at different portions (e.g., depth, view) of an object 180 to be imaged simultaneously. Additionally or alternatively, each signal may be of a different power level and/or wavelength such that resultant signals include signals indicative of multiple types of information regarding the same portion or view of the imaged object 180. For example, the plurality of signals may include a first signal and second signal. The first signal may be indicative of a structure of the object 180. The second signal may be indicative of a temperature of the object 180.

The generated signals may be directed from the source 130 to circulator 140. The circulator 140 or wavelength splitter, such as a single mode circulator, may be configured to route incoming and outgoing signals while keeping them on at least partially separate paths. In this regard, the circulator 140 may be configured to isolate forward and backward propagating signals such that transmitted signals may be routed to the OPA 120 for transmission and received signals may be routed to receiver components for receipt. As such, when transmitting signals, the circulator 140 may connect to and route signals to the OPA 120 of the device for transmission. The one or more processors 170 may be configured induce the OPA 120 to control the phase and amplitude of outgoing signals. The phase and amplitude control may allow the OPA 120 to direct signals to the object 180 to be imaged. In this regard, the phase and amplitude control may add tip and tilt to outgoing signals. In some instances, the field of view (FOV) of the OPA 120 may be 10 degrees or more or less.

Signals may be received at the OPA 120. The one or more processors 170 may be configured to induce the OPA 120 to control the phase and amplitude of received signals to correct for aberrations and/or distortions therein. In this regard, the one or more processors 170 may be configured to monitor and optimize transmitted signals using signals and information thereof received at the one or more PDs 160. In this regard, the one or more PDs 160 can be configured as a direct wavefront sensor and/or utilize algorithms to optimize the received power by dithering an orthonormal basis set such as, for example, Walsh functions. The power may be optimized by controlling one or more phase and amplitude settings of the OPA 120. In some instances, the one or more phase and amplitude settings may be used as active feedback. In this regard, the one or more phase and amplitude settings may be used in transmission of future signals.

The received signals may be routed from the OPA 120 of the device to the circulator 140. As stated above, the circulator 140 may route received signals to receiver components. As illustrated in FIG. 1, the receiver components may include the one or more amplifiers 150 and the one or more PDs 160. In some examples the one or more amplifiers 150 may be one or more SOAs. In some examples, the receiver components may additionally include an attenuator, such as a variable optical attenuator, and/or a filter.

The one or more amplifiers 150 may be configured to increase the power of (e.g., amplify) received signals. The received signals may be directed from the amplifiers 150 to the one or more PDs 160. The one or more PDs 160 may be configured to convert the amplified received signals into the electrical domain. The converted received signal may be digitized by an Analog to Digital Converter (ADC) and further processed by the one or more processors 170 (e.g., an application specific integrated circuit (ASIC) or another hardware-based processor, such as a field programmable gate array (FPGA).

The one or more processors 170 may be further configured to process received signals to form an image. In some instances the image may be a 3D image. In this regard, each received signal corresponding to a different portion or view of the object 180 may be individually processed by the one or more processors 170. The different portions or views of the object 180 may correspond to different locations in the xy-plane, xz-plane, yz-plane, or any combination thereof. The different portions or views may or may not overlap.

The one or more processors 170 may be further configured to combine the processed signals to form a 3D image of the object 180. Additionally or alternatively, the one or more received signals may correspond to the same portion or view of the object 180 to be imaged. In such an instance, the one or more signals corresponding to the same portion or view of the object 180 may be processed individually and then may be combined to form a 3D image. For example, a first signal and second signal may correspond to the same portion or view of an object may be received. The first signal may be indicative of a structure of the object. The second signal may be indicative of one or more spectroscopic attributes of the object. The one or more spectroscopic attributes may include at least one or more of temperature, material identification or biological functionality level determinations. In this regard, the 3D image resulting from the processing of the first and second signals may include both structural and spectroscopic information of the object.

In some instances, image collection may occur iteratively where 3D images may be collected and processed with higher and higher resolution scans which require more collection time and processing time sequentially. In this regard, the one or more processors 170 may be configured to drive the OPA 120 to take images of higher resolution over time and process such images sequentially.

While the one or more processors 170 are illustrated as a portion of the PIC 110, in some instances, the one or more processors 170 may be disposed off-PIC within the device 100. Additionally or alternatively, the device 100 may include additional one or more processors separate from the one or more processors 170 of the PIC. The additional one or more processors may be configured in the same or similar manner as the one or more processors 170 and have the same or similar capabilities of the one or more processors 170.

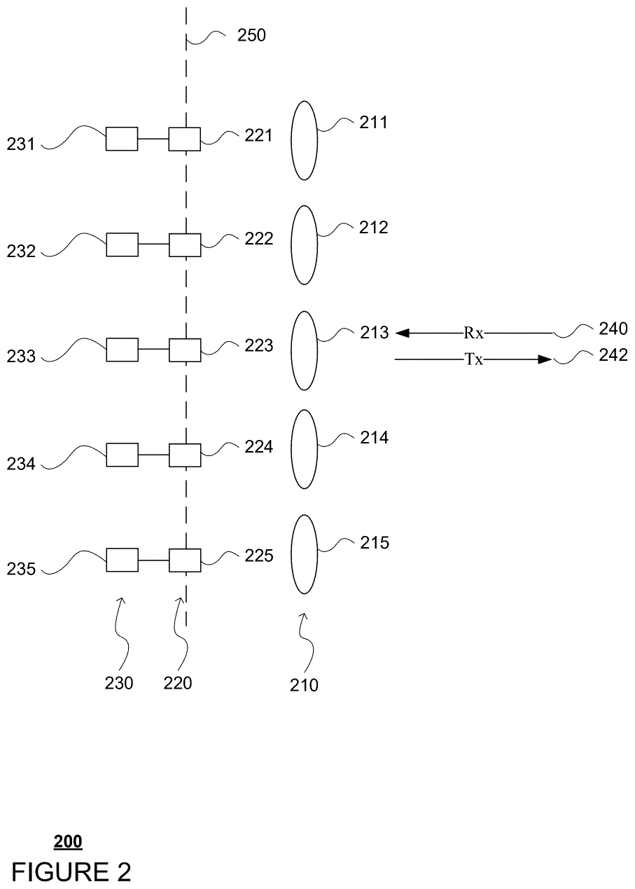

FIG. 2 represents features of OPA architecture represented as an example OPA architecture 200. The OPA architecture 200 may be representative of components of the OPA 120, and associated components thereof. The OPA architecture 200 includes representations of a micro-lens array 210, a plurality of emitters or optical antennas 220, and a plurality of phase and amplitude modulators 230. For clarity and ease of understanding, additional waveguides and other features are not depicted. Arrows 240, 242 represent the general direction of transmitted and received signals (e.g., reflected back signals, emitted signals) as such light passes or travels through the OPA architecture 200.

The micro-lens array 210 may include a plurality of convex micro-lens 211-215 that focus the received signals onto respective ones of the plurality emitters positioned at the focal points of the micro-lens array 210. In this regard, the dashed-line 250 represents the focal plane of the micro-lens 211-215 of the micro-lens array 210. The micro-lens array 210 may be arranged in a grid pattern with a consistent pitch, or distance, between adjacent lenses. In other examples, the micro-lens array 210 may be in different arrangements having different numbers of rows and columns, different shapes, and/or different pitch (consistent or inconsistent) for different lenses.

Each micro-lens of the micro-lens array may be 1's, 10's, or 100's of micrometers in diameter and/or height. In addition, each micro-lens of the micro-lens array may be manufactured by molding, printing, or etching a lens directly into a wafer of the OPA architecture 200. Alternatively, the micro-lens array 210 may be molded as a separately fabricated micro-lens array. In this example, the micro-lens array 210 may be a rectangular or square plate of glass or silica a few mm (e.g., 10 mm or more or less) in length and width and 0.2 mm or more or less thick. Integrating the micro-lens array within the OPA architecture 200 may allow for the reduction of the grating emitter size and an increase in the space between emitters. In this way, two-dimensional waveguide routing in the OPA architecture 200 may better fit in a single layer optical phased array. In other instances, rather than a physical micro-lens array, the function of the micro-lens array may be replicated using an array of diffractive optical elements (DOE).

Each micro-lens of the micro-lens array may be associated with a respective emitter of the plurality of emitters 220. For example, each micro-lens may have an emitter from which transmitted signals are received and to which the received signals are focused. As an example, micro-lens 211 is associated with emitter 221. Similarly, each micro-lens 212-215 also has a respective emitter 222-225. In this regard, for a given pitch (i.e., edge length of a micro-lens edge length) the micro-lens focal length may be optimized for best transmit and receive coupling to the underlying emitters. This arrangement may thus increase the effective fill factor of the received signals at the respective emitter, while also expanding the transmitted signals received at the micro-lenses from the respective emitter before the transmitted signals leave the OPA architecture 200.

The plurality of emitters 220 may be configured to convert emissions from waveguides to free space and vice versa. The emitters may also generate a specific phase and intensity profile to further increase the effective fill factor of the received signals and improve the wavefront of the transmitted signals. The phase and intensity profile may be determined using inverse design or other techniques in a manner that accounts for how transmitted signals will change as they propagate to and through the micro-lens array. The phase profile may be different from the flat profile of traditional grating emitters, and the intensity profile may be different from the gaussian intensity profile of traditional grating emitters. However, in some implementations, the emitters may be Gaussian field profile grating emitters.

The phase and amplitude modulators 230 may allow for sensing and measuring received signals, the altering the phase and amplitude of transmitted signals, and the combining of input light into a single waveguide or fiber. Each emitter may be associated with a phase and amplitude modulator. As shown in FIG. 2, each emitter may be connected to a respective phase and amplitude modulator. As an example, the emitter 221 is associated with a phase and amplitude modulator 231. The received signals received at the phase and amplitude modulators 231-235 may be provided to receiver components and the transmitted signals from the phase and amplitude modulators 231-235 may be provided to the respective emitters of the plurality of emitters 220. The architecture for the plurality of phase and amplitude modulators 230 may include at least one layer of phase and amplitude modulators having at least one phase and amplitude modulator connected to an emitter of the plurality of emitters 220. In some examples, the phase and amplitude modulator architecture may include a plurality of layers of phase and amplitude modulators, where phase and amplitude modulators in a first layer may be connected in series with one or more phase and amplitude modulators in a second layer.

While the PIC 110 of FIG. 1 and the OPA architecture 200 of FIG. 2 are configured to both transmit signals to an object to be imaged and receive signals reflected back and/or emitted from the object, in some instances, a device used in optical imaging may include a separate receiver configured to receive signals reflected back and/or emitted from the object. In one example, the receiver may include an OPA and receiver components. The receiver components may include one or more amplifiers and one or more PDs configured in a similar manner as the one or more amplifiers 150 and the one or more PDs of PIC 110. In some instances, the PDs may be avalanche photodiodes or InGaAs photodiodes. The receiver components may additionally include an attenuator, such as a variable optical attenuator, and/or a filter. In another example, the receiver components may include one or more sensors, such as, for example, a camera (e.g., charge coupled camera, IR camera)or a photomultiplier tube (PMT), or a single photon. The device may further include additional components to facilitate receipt of signals.

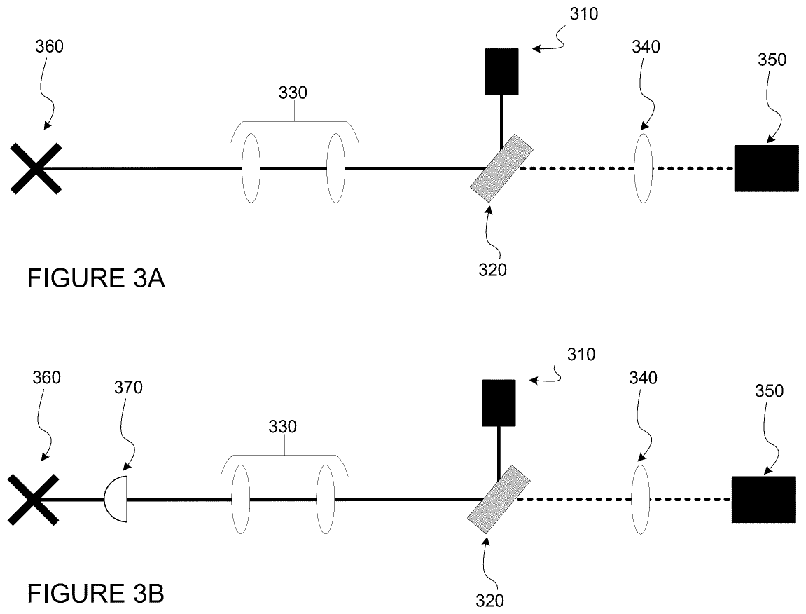

FIGS. 3A-3B illustrate example device configurations including receiver 350. In FIG. 3A, the device used in optical imaging includes PIC 310, mirror 320, lens group 330, lens 340, and receiver 350. FIG. 3A additionally illustrates object 360 to be imaged. Object 360 may include biological tissue. For example, object 360 may be a tissue sample, a human, an animal, etc.

PIC 310 may be configured to generate and transmit signals in a similar manner as PIC 110. In this regard, PIC 310 may include a source. The source may be configured to generate signals (e.g., light). The source may be a distributed feedback laser (DFB), a laser diode, a fiber laser, a solid-state laser, an extended cavity diode laser (ECL), or a seed laser. In some instances, the source may be a semiconductor optical amplifier (SOA) configured to generate and control a power level of signals (e.g., amplify). The power level control may allow for control of imaging depth, imaging range, etc. Additionally, the power level may be controlled such that the level remains within a safe range for the object 360 being imaged. For example, if the object 360 includes biological tissue, the power level may be controlled such that the signals do not damage the biological tissue. The generated signals may be directed from the source to an OPA for transmission. The OPA may be configured in a similar manner as the OPA architecture 200 of FIG. 2. The PIC 310 may additionally include one or more processors. The one or more processors may be configured in the same or similar manner as the one or more processors 170 and/or the additional one or more processors discussed with respect to of FIG. 1.

Generated signals from the PIC 310 may be directed towards mirror 320. In some instances, mirror 320 may be a dichroic mirror. The dichroic mirror may include different reflection or transmission properties of signals at different wavelengths. In this regard, mirror 320 may be configured to direct signals from PIC 310 towards the object 360 to be imaged through lens group 330. Additionally mirror 320 may be configured to direct signals reflected back and/or emitted from object 360 towards receiver 350 through lens 340. Lens group 330 may include one or more beam extending lenses. The one or more beam extending lenses may be configured to increase a numerical aperture of the signals directed towards object 360. The increased numerical aperture may allow for an increased FOV of the device.

Signals reflected back and/or emitted from object 360 may pass through lens group 330, mirror 320, and lens 340 towards receiver 350. Lens group 330 may be configured to decrease the numerical aperture of signals reflected back and/or emitted from object 360. Mirror 320 may be configured to direct signals reflected back from object 360 towards receiver 350. Reflected back and emitted signals may have a wavelength different from signals transmitted from PIC 310. Lens 340 may be configured to focus signals onto receiver 350.

Receiver 350 may be configured to receive signals for processing. In one example, the receiver 350 may include an OPA and receiver components. The receiver components may include one or more amplifiers and one or more PDs configured in a similar manner as the one or more amplifiers 150 and the one or more PDs of PIC 110. In some instances, the PDs may be avalanche photodiodes or InGaAs photodiodes. The receiver components may additionally include an attenuator, such as a variable optical attenuator, and/or a filter. In another example, the receiver components may include one or more sensors, such as, for example, a camera (e.g., charge coupled camera, IR camera), a photomultiplier tube (PMT), or a single photon counting superconducting nanowire array.

Receiver 350 may be operatively coupled to one or more processors of the device. The one or more processors of the device may be the same or different processors as the one or more processor of the PIC 310. The one or more processors of the device may be configured in a similar manner as the one or more processors 170 and/or the additional one or more processors discussed with respect to of FIG. 1. In this regard, the one or more processors of the device may be configured to process received signals to form an image. In some instances the image may be a 3D image. In this regard, each received signal corresponding to a different portion or view of the object may be individually processed by the one or more processors of the device. The different portions or views of the object may correspond to different locations in the xy plane, xz plane, yz plane, or any combination thereof. The different portions or views may or may not overlap. The one or more processors of the device may be further configured to combine the processed signals to form a 3D image of the object. Additionally or alternatively, the one or more received signals may correspond to the same portion or view of the object to be imaged. In such an instance, the one or more signals corresponding to the same portion or view of the object may be processed individually and then may be combined to form a 3D image. For example, a first signal and second signal may correspond to the same portion or view of an object may be received. The first signal may be indicative of a structure of the object. The second signal may be indicative of one or more spectroscopic attributes of the object. The one or more spectroscopic attributes may include at least one or more of temperature, material identification or biological functionality level determinations. In this regard, the 3D image resulting from the processing of the first and second signals may include both structural and spectroscopic information of the object.

In some instances, image collection may occur iteratively where 3D images may be collected and processed with higher and higher resolution scans which require more collection time and processing time sequentially. In this regard, the one or more processors 170 may be configured to drive the OPA 120 to take images of higher resolution over time and process such images sequentially.

FIG. 3B illustrates a different configuration of a device used in optical imaging. The example device used in optical imaging similarly includes PIC 310, mirror 320, lens group 330, lens 340, and receiver 350. FIG. 3B illustrates object 360 to be imaged. The device of FIG. 3B further includes objective lens 370. Objective lens 370 may be configured to direct transmitted signals towards object 360 and reflected back and/or emitted signals towards receiver 350.

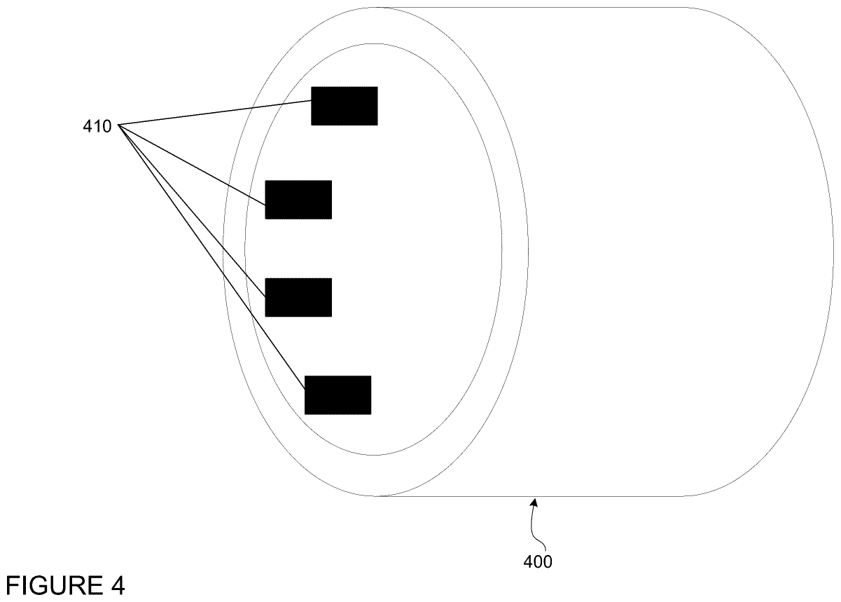

In some instances, the device used in optical imaging may include a plurality of PICs. In this regard, each PIC of the device may have a differing FOV during imaging. Each differing field of view may or may not overlap. FIG. 4 illustrates an example device 400 including a plurality of PICs 410. Each of the plurality of PICs 410 may be configured in the same manner as PIC 110 of FIG. 1.

Each PIC of the plurality of PICs 410 may be formed as an array. While FIG. 4 illustrates the plurality of PICs 410 in a hollow cylinder array, the plurality of PICs 410 may be arranged in numerous array configurations (e.g., circular, n×m, n×n, etc.) such that the overall FOV of the plurality of PICS does not include dead zones.

Each of the plurality of PICs 410 may be configured to transmit and receive signals in a differing FOV during imaging. The differing FOVs may or may not overlap such that an object or region thereof may be imaged. In some instances, the differing FOVs may include differing depths within an object to be imaged. As discussed above, in some instances, each PIC may be configured as a multi-wavelength PIC. In this regard, each PIC may be configured to transmit a plurality of signals simultaneously. Each signal may be of a different power and/or wavelength and may allow for imaging at different depths of an object to be imaged simultaneously. Additionally or alternatively, each signal may be of a different power level and/or wavelength such that resultant signals include signals indicative of multiple types of information regarding the same portion or view of the imaged object. For example, the plurality of signals may include a first signal and second signal. The first signal may be indicative of a structure of the object. The second signal may be indicative of a temperature of the object.

In some instances, two or more PICs of the plurality of PICs 410 may be configured to transmit signals to the same portion of the object. In such an instance, the signals from the two or more PICs may be configured to constructively interfere such that the power of the resultant signal is increased. The increased power may allow for increased imaging depth within the object.

The plurality of PICs 410 may be further configured to be phase synchronized and/or phase locked during imaging. In this regard, the phases of signals transmitted from each PIC may be selected and/or locked during imaging to reduce interference between signals transmitted from other PICs of the plurality of PICs 410. Additionally, the phases of the signals transmitted from each PIC may be selected to reduce interference between reflected back and/or emitted signals. Such selection and reduction of interference may enable improved imaging depths, resolution, and faster scanning rates.

As discussed above, the device or imaging device may be used in optical imaging. The imaging device may include a PIC therein. The PIC may include an OPA configured to transmit and receive incoming and outgoing signals. In this regard, an imaging device (e.g. optical imaging device, camera, medical imaging device, etc.) may be configured to image an object. The object may be, for example, a tissue sample, a human, an animal, etc. In one example,, the device for optical imaging may be used in retinal imaging applications. In such an example, the device may be configured to image differing depths within an eye. The device may control a PIC thereof or multiple PICs thereof to generate signals at power levels such that the signals will be reflected back and/or emitted from different layers of the eye. These layers include the superficial vasculatures, the intermediate vasculatures, the deep vasculatures, and the choroidal vasculatures. The power levels of the signal are such that the multiple layers of the eye may be imaged but not damaged. In a further example, the device for optical imaging or portions thereof may be implanted into a subject (e.g., human, animal) for imaging. In such an example, the device may be configured to internally transmit signals to the subject. Resultant signals from the transmitted signals may include excitation signals of the object. The resultant signals may be received at a receiver external from the subject for processing.

Moreover, the device described herein may be configured as numerous types of imaging devices. In this regard, the device can be used in numerous types of imaging. Such types of imaging may include high density diffuse optical tomography (HD-DOT), functional imaging (e.g., how a cell is functioning), neural imaging and vascular imaging, and full or partial body scan (e.g., in lieu of a magnetic resonance imaging (MRI) device or a computed tomography (CT) device). The features of the device described herein may be further used in additional applications. These additional applications may include focused ultrasound for seizures (e.g., biological stimulation), surgery (e.g., optical guidance and 3D focused beam targets tissue), brain machine interface (e.g., read brain activity and control extraneous devices), measurement of nerve activity and control a device based thereon (e.g., control of a prosthesis, or artificial limb), time of flight imaging (e.g., see around an obstacle, see through an obstacle), robotics/autonomous vehicles, security scans (e.g., body scans at airport security), imaging through scattered material (e.g., scan for thermal to locate fires in emergency), 3D printing (e.g., activate photoactive compounds for phototherapy and polymerize photoactive compounds to solidify and print 3D structures with the OPA volumetric scanning capabilities with OPA volumetric scanning to solidify and print material), optically stimulate photocells for remote power applications, and transmitting light to elicit a photocurrent remotely to essentially transmit electricity.

### Example Methods

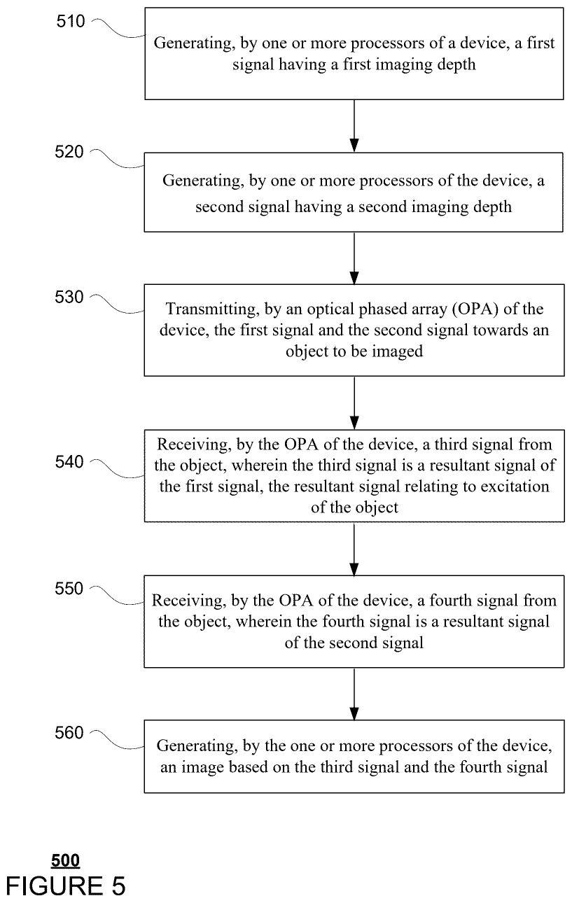

The device discussed above may be used in a method of optical imaging. FIG. 5 illustrates an example method 500 of capturing one or more images using an imaging device. At block 510, the method includes generating, by one or more processors of a device, a first signal having a first imaging depth. At block 520, the method includes generating, by one or more processors of the device, a second signal having a second imaging depth. In this regard, the device may be configured to generate signals from one or more PICs 110, 310, 410 of the device towards an object to be imaged. In some instances, the signals may be generated from a plurality of PICs 410. One or more processors 170 of the device may induce a source 130 of the device to generate signals (e.g., light) as discussed above. The one or more processors 170 may be configured to control the source 130 to generate signals at specific wavelengths. The wavelength of the signals may be selected for control of imaging depth, imaging range, etc. The one or more processors 170 may be further configured to control the source 130 to control power levels of the signals. The power level control may allow for control of imaging depth, imaging range, etc. For example, increased power may allow for increased imaging depth within the object. Similarly, decreased power may allow for decreased imaging depth including surface level imaging of an object. Additionally, the power level may be controlled such that the level remains within a safe range for the object being imaged. For example, if the object includes biological tissue, the power level may be controlled such that the signals do not damage the biological tissue.

In some instances, the source may be configured to generate multiple signals at differing wavelengths and/or power levels simultaneously. Each signal may be of a different power and/or wavelength and may allow for imaging at different portions (e.g., depth, view) of an object to be imaged simultaneously. Additionally or alternatively, each signal may be of a different power level and/or wavelength such that resultant signals include signals indicative of multiple types of information regarding the same portion or view of the imaged object. For example, the plurality of signals may include a first signal and second signal. The first signal may be indicative of a structure of the object. The second signal may be indicative of a temperature of the object.

In some instances, two or more PICs of a plurality of PICs 410 may be configured to transmit signals to the same portion of the object. In such an instance, the signals from the two or more PICs may be configured to constructively interfere such that the power of the resultant signal is increased. The increased power may allow for increased imaging depth within the object.

At block 530, method includes transmitting, by an optical phased array (OPA) of the device, the first signal and the second signal towards an object to be imaged. In this regard, an OPA 120, 200 may be configured to transmit signals towards the object to be imaged. The one or more processors 170 may be configured induce the OPA 120, 200 to control the phase and amplitude of outgoing signals. The phase and amplitude control may allow the OPA 120, 200 to direct signals to the object to be imaged. In this regard, the phase and amplitude control may add tip and tilt to outgoing signals. In some instances, the FOV of the OPA 120, 200 may be 10 degrees or more or less.

At block 540 the method includes receiving, by the OPA of the device, a third signal from the object, wherein the third signal is a resultant signal of the first signal, the resultant signal relating to excitation of the object. At block 550 the method includes, receiving, by the OPA of the device, a fourth signal from the object, wherein the fourth signal is a resultant signal of the second signal. In this regard, the OPA 120, 200 may be configured to receive from the object. The signals received may be signals resulting (e.g., resultant signals) from the transmitted signals. In this regard, the received signals may be the transmitted signals reflected back from the object and may be the result of excitation of the object. For example, a first signal may be transmitted from the device to the object to be imaged of a portion thereof. The first signal may excite the object or a portion thereof such that a second signal may be emitted and received by the device.

The excitations can include, but not be restricted to, single wavelength excitation; dual wavelength excitation, and coherent superposition. Single wavelength excitation may include excitation using a single wavelength. Single wavelength excitation may be used for measurements of physical attributes such pressure, velocity, density, biological activity, temperature, material ablation and surgical removal structure sculpting and 3D dimensional modification polymerization and growth of 3D structures photo-activation of photosensitizing drugs (e.g., for cancer treatment). Dual wavelength excitation may include excitation using two wavelengths. Dual wavelength excitation may be used for coherent ultrasound generation for deeper object penetration, Raman excitation for material identification, and O2 saturation levels. Coherent superposition excitation may use a plurality of wavelengths and may provide a localized effect that leaves surrounding areas unaffected.

In some instances, the one or more processors 170 may be configured to induce the OPA 120, 200 to control the phase and amplitude of received signals to correct for aberrations and/or distortions therein.

At block 560, the method includes generating, by the one or more processors of the device, an image based on the third signal and the fourth signal. In this regard, the one or more processors 170 may be configured to process received signals to form an image. In some instances the image may be a 3D image. In this regard, each received signal corresponding to a different portion or view of the object may be individually processed by the one or more processors 170. The different portions or views of the object may correspond to different locations in the xy-plane, xz-plane, yz-plane, or any combination thereof. The different portions or views may or may not overlap. The one or more processors of the device (e.g., one or more processors 170, one or more additional processors) may be further configured to combine the processed signals to form a 3D image of the object.

Additionally or alternatively, the one or more received signals may correspond to the same portion or view of the object to be imaged. In such an instance, the one or more signals corresponding to the same portion or view of the object may be processed individually and then may be combined to form a 3D image. For example, a first signal and second signal may correspond to the same portion or view of an object may be received. The first signal may be indicative of a structure of the object. The second signal may be indicative of one or more spectroscopic attributes of the object. The one or more spectroscopic attributes may include at least one or more of temperature, material identification or biological functionality level determinations. In this regard, the 3D image resulting from the processing of the first and second signals may include both structural and spectroscopic information of the object.

In some instances, image collection may occur iteratively where 3D images may be collected and processed with higher and higher resolution scans which require more collection time and processing time sequentially. In this regard, the one or more processors 170 may be configured to drive the OPA 120 to take images of higher resolution over time and process such images sequentially.

The features and methodology described herein may provide an imaging device utilizing the functional capabilities of the OPA to facilitate imaging over larger areas and depths with decreased complexity and cost. Use of the OPA may also enable focusing of light or signals onto specific targets within the object for more localized and enhanced interactions. Moreover, due to the small size, low power consumption and inert material basis of imaging devices including a PIC, such devices may be utilized for external and internal body imaging applications. Additionally such devices may be configured to be implanted within a human, animal, etc., for longer term, real time, monitoring or therapeutic applications.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only some of many possible embodiments. Further, the same reference numbers in different drawings can identify the same or similar elements.

1. An optical imaging device comprising:
a source configured to generate signals;
an optical phased array (OPA), operatively coupled to the source, the OPA being configured to transmit signals from the source towards an object to be imaged;
a receiver configured to receive resultant signals from the object, wherein the resultant signals are based on the transmitted signals and the resultant signals include at least one signal relating to excitation of the object; and
one or more processors operatively coupled to the OPA, the receiver, and the source, the one or more processors configured to generate an image based on received resultant signals.

2. The optical imaging device of claim 1, wherein the source, the OPA, and the one or more processors are included on a first photonic integrated circuit (PIC).

3. The optical imaging device of claim 2, wherein the receiver is included on the first PIC.

4. The optical imaging device of claim 2, further comprising a plurality of PICs each including a source, and an OPA.

5. The optical imaging device of claim 4, wherein each PIC of the plurality of PICs has a differing field of view (FOV).

6. The optical imaging device of claim 4, wherein the first PIC and the plurality of PICs are formed in an array.

7. The optical imaging device of claim 6, wherein the array is a hollow cylinder.

8. The optical imaging device of claim 1, further comprising a mirror configured to direct signals from the OPA towards the object to be imaged and resultant signals towards the receiver.

9. The optical imaging device of claim 8, wherein the mirror is a dichroic mirror including different reflection or transmission properties of signals at different wavelengths.

10. The optical imaging device of claim 1, further comprising a lens group including one or more beam extending lenses, the beam extending lenses configured to increase a numerical aperture of signals directed towards the object to be imaged.

11. The optical imaging device of claim 1, further comprising a lens configured to focus signals onto the receiver.

12. The optical imaging device of claim 1, wherein the receiver includes a camera, a photomultiplier tube (PMT), or a single photon counting superconducting nanowire array.

13. The optical imaging device of claim 1, wherein the receiver includes one or more amplifiers and one or more photodiodes.

14. The optical imaging device of claim 1, wherein the image is a 3D image.

15. The optical imaging device of claim 1, wherein the image includes both structural and spectroscopic information of the object.

16. The optical imaging device of claim 15, wherein the spectroscopic attributes include at least one or more of temperature, material identification or biological functionality level determinations.

17. A method of optical imaging, the method comprising:
generating, by one or more processors of a device, a first signal having a first imaging depth;
generating, by the one or more processors of the device, a second signal having a second imaging depth;
transmitting, by an optical phased array (OPA) of the device, the first signal and the second signal towards an object to be imaged;
receiving, by the OPA of the device, a third signal from the object, wherein the third signal is a resultant signal of the first signal, the resultant signal relating to excitation of the object;
receiving, by the OPA of the device, a fourth signal from the object, wherein the fourth signal is a resultant signal of the second signal; and
generating, by the one or more processors of the device, an image based on the third signal and the fourth signal.

18. The method of claim 17, wherein the device is an optical imaging device.

19. The method of claim 17, wherein the object includes biological tissue.

20. The method of claim 17, wherein the first imaging depth is different from the second imaging depth.
